(19) United States
(12) Patent Application Publication
(10) Pub. No.: US 2013/0037734 A1
(43) Pub. Date: Feb. 14, 2013

(54) VALVE DEVICE WITH GAP SEAL INJECTION-MOULDED ONTO VALVE, METHOD AND SEMI-FINISHED PRODUCT FOR THE PRODUCTION THEREOF

(71) Applicants: Dieter Kerschbaumer, Tramin (IT); Ferdinand Di Pauli, Bozen (IT)

(72) Inventors: Dieter Kerschbaumer, Tramin (IT); Ferdinand Di Pauli, Bozen (IT)

(73) Assignee: ROECHLING AUTOMOTIVE AG & CO. KG, Worms (DE)

(21) Appl. No.: 13/572,923

(22) Filed: Aug. 13, 2012

(30) Foreign Application Priority Data
Aug. 12, 2011 (EP) 11 177 437.8

(51) Int. Cl. B29C 45/16; F02D 9/08

(52) U.S. Cl. 251/205; 264/328.1; 264/138; 264/259

(57) ABSTRACT

A method of producing by moulding a valve device, the valve device comprising a housing, which surrounds a flow duct portion, and additionally comprising a valve accommodated on the housing and movable relative thereto such that, by relative adjustment of the valve relative to the housing, the effective flow area of the flow duct portion is modifiable, wherein the housing and the valve already accommodated thereon are formed shapingly in a moulding tool in a common moulding step from a flowable moulding compound, with one-piece formation of a moulding material membrane, together with the valve and the housing, the moulding material membrane being provided between an outer valve portion, and a housing portion surrounding the valve portion, in a shut-off position of the valve relative to the housing, in which shut-off position the flow area of the flow duct portion is as a rule minimal.

The present invention relates to a method of producing a valve device, in particular a throttle device, preferably for use in motor vehicles, by moulding, in particular injection moulding, the valve device comprising a housing, which surrounds a flow duct portion, and additionally comprising a valve accommodated on the housing and movable relative thereto such that, by relative adjustment of the valve relative to the housing, the effective flow area of the flow duct portion is modifiable.

The present invention further relates to a semi-finished product for the production of the above-stated valve device and to the valve device itself. The above-stated valve device, which may comprise one or more valves and as a rule one flow duct portion per valve, is preferably suitable for use in motor vehicles, in order to modify gas flows of all kinds, such as for instance a fresh gas feed to the internal combustion engine, with regard to quantity by relative adjustment of the at least one valve relative to the housing. It is known, moreover, to produce components of such a valve device, such as for example the valve on the one hand and the housing on the other hand, inexpensively using injection moulding.

However, a leakage problem may arise, specifically with injection-moulded components of the valve device.

Due to shrinkage and/or expansion of the moulding material after solidification in the mould, in particular after demoulding, leakage problems may arise in the gap area between valve and housing. This gap leakage is particularly significant when the valve is intended to close the flow duct portion of the housing associated therewith substantially completely in a shut-off position.

Manufacturing method-related inaccuracies may then result in the formation of an undesired annular gap between an outer valve edge and a housing portion surrounding this outer valve edge in t48929P EPhe above-described valve shut-off position. As a result of this annular gap, gas may continue to flow through the flow duct portion although complete shut-off of the flow duct portion is actually desired.

To seal this undesired annular gap, in the prior art a separately produced seal is frequently fitted to the valve in an assembly step, but this is complex and expensive.

It is therefore the object of the present invention to indicate technical teaching with which the above-stated valve device may furthermore be produced inexpensively and in large numbers and which allows reduction or even elimination of the above-described leakage problem.

According to a first aspect of the present invention, this object is achieved by a method of the above-mentioned type, in which the housing and the valve already accommodated thereon are formed shapingly in a moulding tool in a common moulding step from a flowable moulding compound, with one-piece formation of 48929P EP a moulding material membrane, which is thin compared with the wall thicknesses of the housing and of the valve, together with the valve and the housing, the moulding material membrane being provided between an outer valve portion and a housing portion surrounding the valve portion in a shut-off position of the valve relative to the housing, in which shut-off position the flow area of the flow duct portion is as a rule minimal.

The term “flow area” in this application in particular but not exclusively designates a flow area in a plane orthogonal to the direction of flow.

Although in the context of the present application an injection moulding method is preferred, other moulding methods should not be ruled out.

By forming the housing and the valve already accommodated thereon in a single common moulding step and in a common moulding tool with common moulding material, it is on the one hand ensured that the material characteristics, such as for instance shrinkage, coefficient of thermal expansion and the like, which have an effect on the dimensional stability of the components of the valve device, are substantially identical for valve and for housing, such that, once achieved, accuracies and dimensions may substantially be maintained even during operation at varying temperatures.

Furthermore, through the common moulding step in a common moulding tool, a semi-finished product is formed, in which preferably at least the outer valve edge, but also any other desired suitable portion of the valve, is connected with the housing portion surrounding it in the shut-off position of the valve by a moulding material membrane which is thin compared with the thickness of the valve or by a thin moulding material burr.

Preferably, housing and valve are thus produced in the moulding step in such a way that the valve is located relative to the housing in the shut-off position, i.e. in a position in which the effective flow area of the flow duct portion is as a rule minimal.

This moulding material membrane is formed thin compared with the material thickness of the valve portion, in particular valve edge, directly adjoining it, so that the moulding material membrane may be severed with a tool, such as for instance a blade, but the valve cannot be penetrated with the same tool or only with unusually strong force.

Then the moulding material membrane formed during the common housing- and valve-moulding step can act as a gap seal. This makes it superfluous to attach a separate seal. It being possible, instead, to avoid an additional seal formed separately from valve and housing otherwise needed in the prior art to prevent the above-described leakage losses.

To ensure the above-described property, the moulding material membrane may exhibit approximately 1% to 40%, preferably 5% to 20%, particularly preferably 5% to 15%, of the wall thickness or average wall thickness of the valve.

This means that although a semi-finished product consisting of housing and valve and produced in this way in one moulding step has the valve already mounted rotatably in the housing, relative rotation of the valve relative to the housing directly after demoulding is however prevented by the moulding material membrane.

This moulding material membrane connecting the valve and housing in one piece may be substantially the only difference between the semi-finished product demoulded after the common moulding step and the finished, i.e. functional, valve device.

To make the valve device functional, the method described herein preferably comprises the step of severing the moulding material membrane. As already described above, this severing may be carried out using a tool, in particular a cutting tool. However, it is in principle also conceivable with a sufficiently thin moulding material membrane to tear the moulding material membrane by forcing relative movement of the valve and housing.

Although the latter method is covered by the present invention, it is not preferred, since such a tearing process may lead to undesired stretching of the moulding material in the moulding material membrane, such that on subsequent operation of the valve device undesired friction may arise between the burr resulting from the stretched and torn moulding material membrane on the outer valve portion, in particular the valve edge, and/or on the relevant housing portion.

To provide maximally precise relative motion, i.e. that is stable with regard to shape and/or dimensions, between valve and housing, it may be advantageous, when the valve in the finished valve device is provided on the housing so as to be rotatable relative thereto about a valve axis, for the method to comprise a method step involving insertion of a valve shaft element into the moulding tool.

The valve shaft element may for example be a metal element or a element of another material, which is more stable with regard to shape than the cured moulding material.

It is then possible to mould, in particular injection mould, the valve onto the valve shaft element, or to encapsulate by (over)moulding, in particular to encapsulate by injection moulding, the valve shaft element with the valve.

In the former case of moulding the valve onto the valve shaft element, the latter is not completely surrounded by moulding material contributing to formation of the valve, while in the case of encapsulation by (over)moulding, the valve shaft element is completely surrounded by moulding material contributing to formation of the valve.

Encapsulation by (over)moulding is preferred, since the encapsulated valve shaft element is on the one hand largely protected by the moulding material of the valve and moreover no undesirable material pairing arises at the outer face of the valve reinforced with the valve shaft element, which material pairing could lead to undesired wear on relative motion of valve and housing.

Furthermore, in the above-stated case of a valve rotatable relative to the housing about a valve axis, the method may comprise the following further method steps:
inserting at least one bearing bush into the moulding tool, preferably two bearing bushes, particularly preferably such that a portion of a valve cavity of the moulding tool is positioned between two bearing bushes associated with the same valve, and
moulding, in particular injection moulding, moulding material contributing to formation of the valve onto a first valve bearing face, associated with the valve, of the bearing bush, and
moulding, in particular injection moulding, moulding material contributing to formation of the housing onto a second housing bearing face of the bearing bush, which second housing bearing face is different from the first valve bearing face and associated with the housing.

By inserting the bearing bush into the moulding tool, a bearing means may thus be provided directly in the moulding tool which, once the moulding process is complete, separates the material of the valve from the material of the housing such that, although the valve is accommodated in the housing and retained thereon, in the region of this support moulding material of the valve and moulding material of the housing are separated from one another by the bearing bush, such that relative motion of valve and housing may arise despite geometric partial penetration of the housing by the valve.

It should not be ruled out that at another location, for instance in a region located axially outside the housing, moulding material of the housing and moulding material of the valve will have flowed together and this flow region has to be separated from the demoulded semi-finished product first, before relative mobility of valve and housing is ensured by severing the moulding material membrane. In this case, a region of such common flow would constitute a further difference, in addition to the moulding material membrane, between the semi-finished product and the finished valve device.

However, such a region of common flow is preferably avoided, in order to keep the extent of the finishing work needed on the moulded semi-finished product as small as possible.

Preferably, both the at least one bearing bush and the valve shaft element are inserted into the moulding tool prior to the moulding process, it being advantageous for the method to comprise the step of threading the valve shaft element into a bearing bush, preferably into all the bearing bushes associated with the valve of the valve shaft element. Then the valve shaft element may pass through the bearing bush and ensure increased stability of the valve and thus of the entire valve device not only between the bearing locations of the valve on the housing, but rather mainly in the bearing locations of the valve on the housing.

As is not difficult to infer from the above description, the technical problem explained above and underlying the present invention is also solved by a semi-finished product for a valve device, in particular a throttle device, preferably for use in motor vehicles, the finished valve device comprising a housing which surrounds a flow duct portion, and additionally comprising a valve accommodated on the housing so as to be movable relative thereto such that, by relative adjustment of the valve relative to the housing, the effective flow area of the flow duct portion is modifiable, in particular produced according to the above-described method, in which at least one valve portion, in particular an outer valve edge, and a housing portion surrounding the valve when the valve device is in the operational state are connected by means of a moulding material membrane which is thin compared with the wall thicknesses of the housing and the valve and are thus formed in one piece.

Such a semi-finished product may be sold commercially as an independently tradable item, for instance by suppliers of automobile components, who supply the semi-finished product with intact moulding material membrane to an automobile manufacturer and leave up to them the time at which the semi-finished product is brought into service, i.e. the time at which the valve device is produced from the semi-finished product by severing the moulding material membrane.

When the valve on the finished valve device is provided on the housing so as to be rotatable relative thereto about a valve axis,—or alternatively a translationally movable valve may also be conceivable—, it is advantageous for the valve to comprise a valve body and at least one valve shaft portion connected thereto for joint movement. The valve body is then preferably that portion of the valve with which the above-described modification of the flow area is brought about by changing the relative arrangement and which is formed for this purpose.

The valve shaft portion, which is formed preferably in one piece with the valve body for reasons of stability with regard to dimensions and shape and to avoid undesired assembly effort, is then formed to accommodate the valve with the valve body rotatably on the housing.

To be able to ensure the sealing action of the moulding material membrane, it is advantageous for the valve edge adjoining the moulding material membrane to be part of the valve body. It is then possible to ensure that the moulding material membrane may actually seal the above-described undesired leakage gap.

Particularly stable support of the valve for relative rotation relative to the housing may be achieved in that the valve comprises two valve shaft portions which are substantially coaxial relative to the valve axis, the valve body being provided axially between the valve shaft portions. By arranging the valve body axially between the valve shaft portions, it is moreover possible to prevent or at least considerably reduce valve bending resulting from loads which may arise during operation, which bending could otherwise impair the relative rotatability of the valve relative to the housing.

In many cases, the valve device or the semi-finished product made for production thereof may comprise a plurality of valves, for instance if a plurality of flow ducts of the same kind lead to each cylinder of a multicylinder internal combustion engine and the gas flow quantity or gas flow rate, respectively, in each of the flow ducts needs to be variable.

It is then extremely advantageous, in order to increase the manufacturing and assembly accuracy and thus for the accuracy of gas flow quantity or gas flow rate, respectively, control or adjustment, for adjacent valves to be couplable or coupled together for joint movement by interlocking geometries.

This means that the valves, which are connected together in the finished valve device for joint relative adjustment relative to the housing, are produced individually, i.e. separately from one another, and coupled together only after production thereof. Therefore, the individual ones of a plurality of valves may still be uncoupled in the semi-finished product, but couplable together by interlocking geometries, or may already be coupled in the semifinished product together for joint movement.

The housing may likewise consist of a plurality of housing parts, for instance of one housing part per valve. It is however likewise conceivable to combine together a plurality of or even all the flow duct portions substantially in a common housing part and merely to add further assembly parts, so as to allow mounting of the valves on the housing part in a manner permitting relative motion.

A structurally simple solution which significantly simplifies subsequent assembly work may be such that the one of two valve shaft portions connected to a valve body comprises a coupling geometry, preferably at a free axial end thereof, and the respective other valve shaft portion comprises a counter coupling geometry, wherein the coupling geometry and the counter coupling geometry being couplable in interlocking manner for joint rotational movement about the valve axis.

Thus, each valve preferably has a coupling geometry at one end and a counter coupling geometry at the other end, such that only one type of valve needs to be produced and this valve may be arranged axially in a row by coupling geometry and counter coupling geometry as many times as desired, in order to achieve the desired number of valves in the respective valve arrangement.

Safe and reliable torque transmission from one valve to the respectively axially adjacent valve, which may be a prerequisite for joint movement, may be achieved in a simple manner in that one geometry of coupling geometry and counter coupling geometry comprises a recess and the respective other geometry comprises a torque-transmitting projection introducible into the recess, preferably a projection complementary to at least one portion of the recess circumference. By appropriate selection of the axial length of recess and projection, the load per unit area of coupling geometry and counter coupling geometry arising at the torque-transmitting coupling location may be kept low.

For example, for torque transmission purposes the projection, like the recess, may have a cross-sectional shape which, with regard to a cross section orthogonal to the valve axis, is bounded by a polygonal line. In general, the projection may be of prismatic configuration, wherein projection and recess may comprise insertion bevels to simplify assembly. This means that the projection tapers with increasing axial distance from the valve body, while the recess tapers as it approaches the valve body.

The preferred complementary configuration of recess and projection is not intended to mean that, when recess and projection are in the coupled state, there are no longer any spaces in the coupling structure, since the recess must conventionally always be a little longer, axially, than the projection. Rather it should be expressed that after coupling the majority of the recess is occupied by the material of the projection.

The above-stated advantages of the semi-finished product also apply mutatis mutandis to the valve device, whose most significant or even only difference consists in the fact that the moulding material membrane, which initially connects valve and housing together, has already been severed in the valve device, leaving behind a burr of the remaining residual material of the moulding material membrane. The above-stated object of the present invention is therefore also achieved by a valve device, in particular a throttle device, preferably for use in motor vehicles, which comprises a housing which surrounds a flow duct portion, and additionally comprises a valve accommodated on the housing and movable relative thereto such that, by relative adjustment of the valve relative to the housing, the effective flow area of the flow duct portion is modifiable in which valve device a valve portion, preferably an outer valve edge of the at least one valve and/or a portion, surrounding the valve, of the housing comprises, as gap seal for the gap remaining between the valve portion, in particular valve edge of the valve, and the housing when the flow area is maximally reduced by the valve, a preferably completely circumferential burr of the same moulding material from which the valve portion, in particular the valve edge of the valve, preferably the entire valve, and the housing portion are produced.

The statements made above with regard to the semi-finished product, in particular the further developments of the semi-finished product according to the invention which solves the initially stated problem, also apply to the above valve device likewise according to the invention as a solution to the problem stated above, which may thus be further developed in the same way as the above semi-finished product. The above further developments of the semi-finished products are therefore also transferable and applicable to the valve device.

If the valve device, as already described above, comprises a plurality of separately manufactured valves, it is advantageous for the valve device to comprise an actuating element with which an actuating torque for relative rotation of valves and housing may be introduced into the valve device by an actuating device, for instance an actuator, in order thereby to be able to actuate the entire valve device at a single actuating location.

The actuating element may already be connected to the at least one valve of the valve device or still be connectable thereto. To simplify assembly work, but also for use of a substantially “universal” valve, not only for coupling to another valve, but also for coupling to the actuating element, it is then advantageous for the actuating element also to comprise a geometry consisting of coupling geometry and mating coupling geometry.

The possibility of coupling together a plurality of individually produced valves by means of the above-stated interlocking geometries is not intended to rule out the possibility of their additionally being operationally connected together non-detachably by bonding, for instance by laser welding, which produces particularly low levels of warping, or by adhesion or otherwise, in order to be able to ensure operation of the valve device with maximally accurate modification of the gas flow quantity or gas flow rate, respectively, through the flow duct portion.

The above-mentioned valve axis may be arranged such that it passes substantially through the valve body, i.e. for instance as in known butterfly valves. It is likewise conceivable for the valve axis to be provided at a distance from the valve body, the valve body then advantageously being of curved construction, such that, in a passage position in which the flow area of the flow duct portion is at its maximum, the valve body may abut against the inner wall of the housing or fit closely thereagainst in a low distance.

In the former case of a butterfly valve, the latter is advantageously planar, i.e. extends along a plane, for reasons of maximally simple manufacture.

The present invention is explained in greater detail below with reference to the attached Figures, in which:

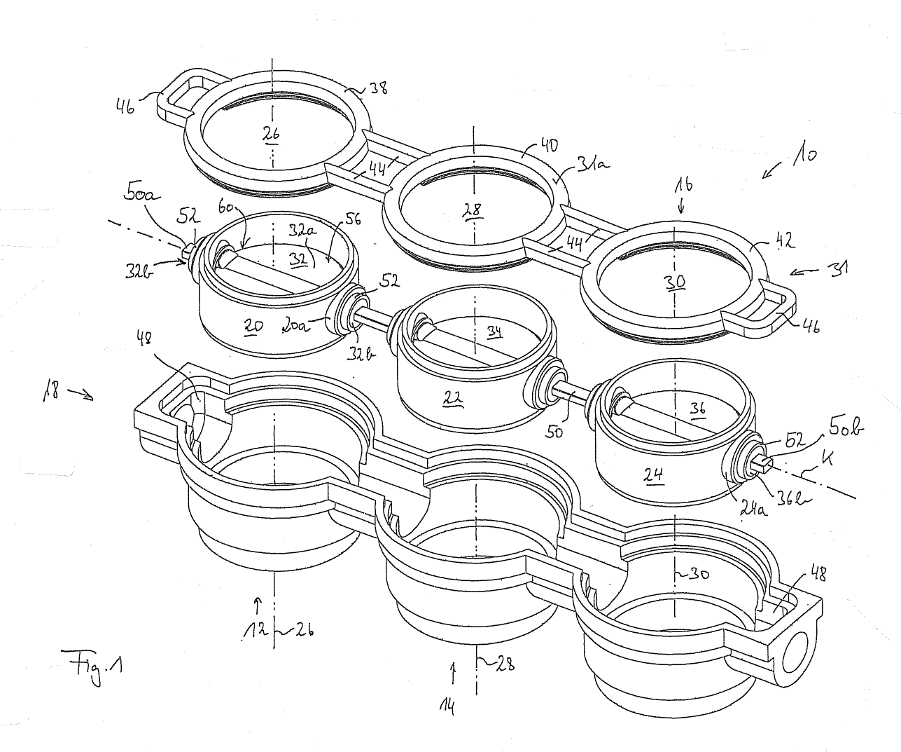

FIG. 1 is a perspective exploded view of a first embodiment according to the invention of a valve device,

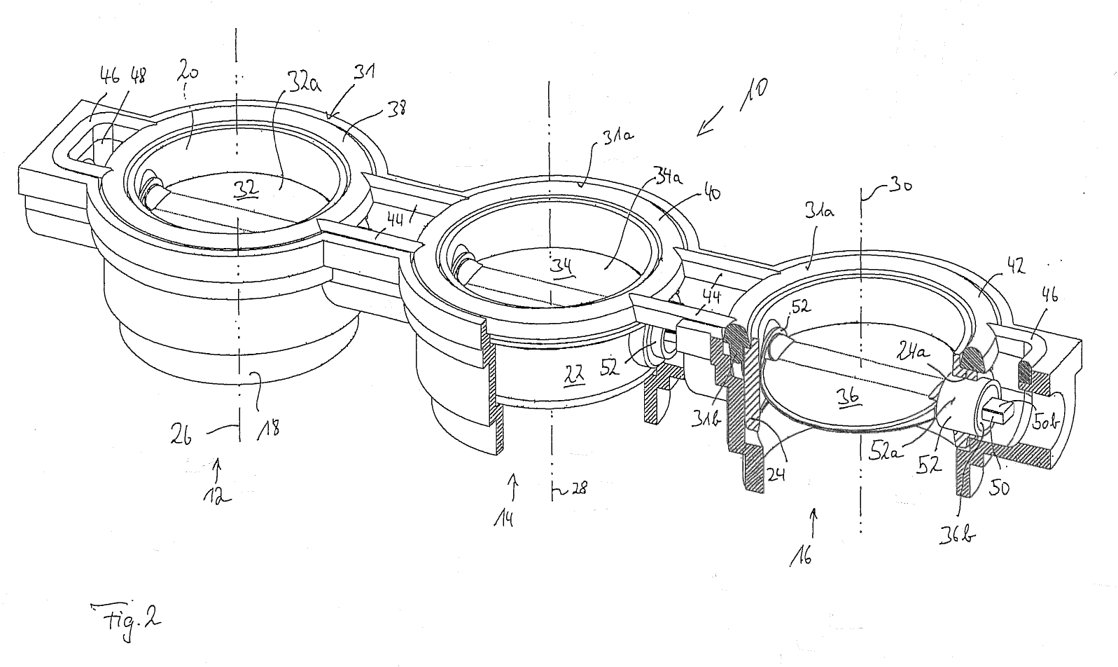

FIG. 2 shows the valve device of FIG. 1 in partial section in the assembled state,

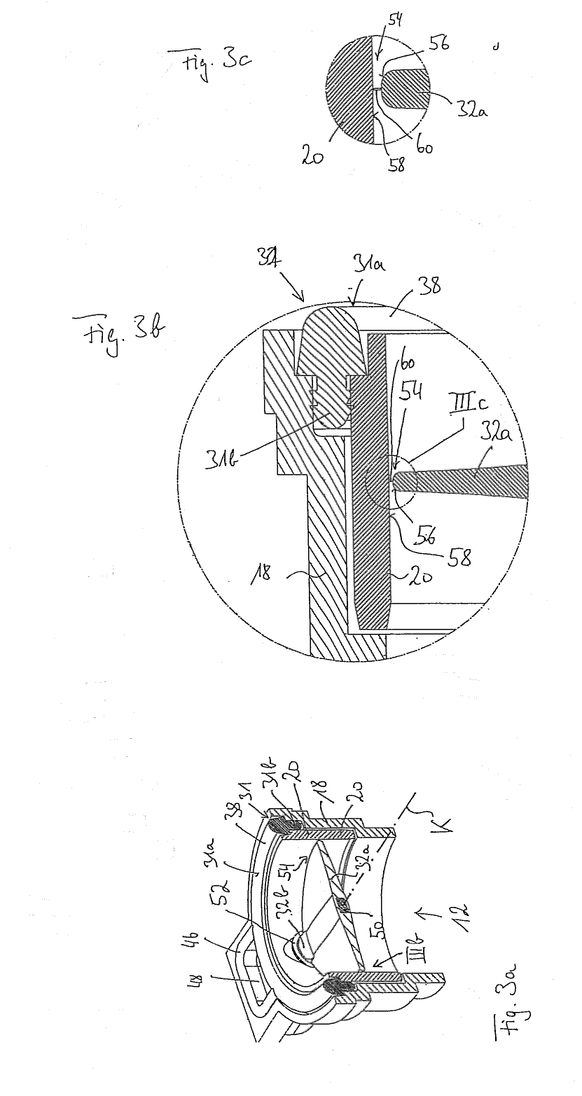

FIG. 3a shows a cross-sectional view through the valve arrangement 12 of FIG. 2 with a cross-sectional plane orthogonal to the valve axis,

FIG. 3b shows an enlarged detail view of the region 111b of FIG. 3a and

FIG. 3c shows an enlarged detail view of the portion 111c of FIG. 3b,

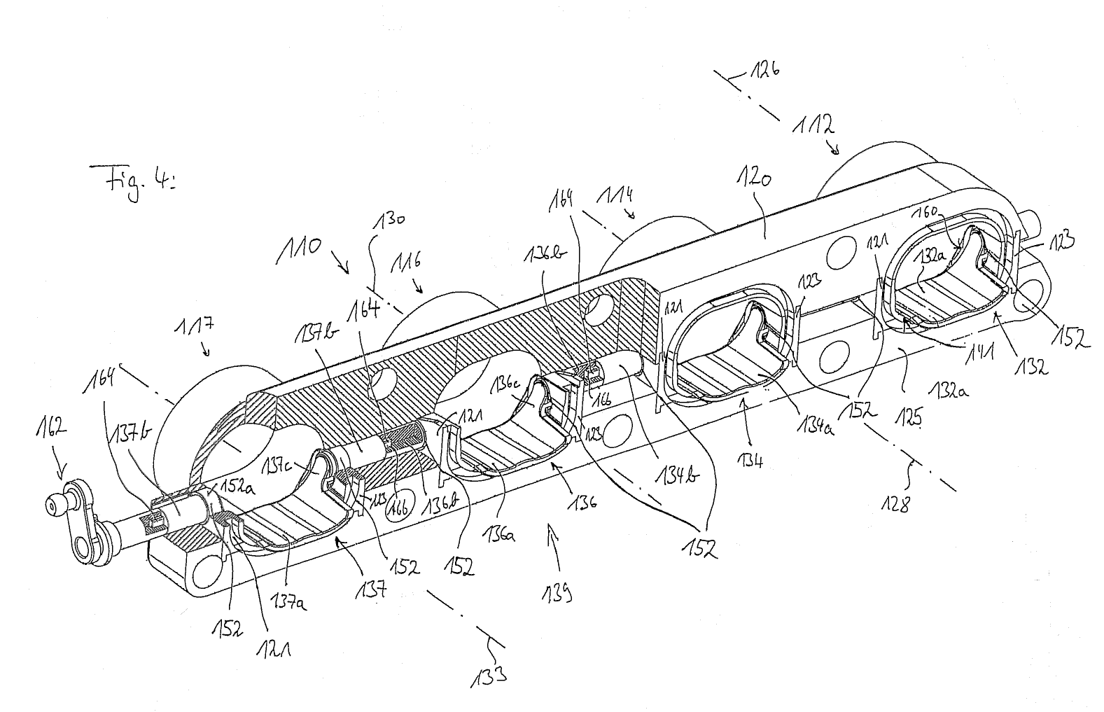

FIG. 4 is a perspective, partially sectional view of a second embodiment of a valve device according to the invention,

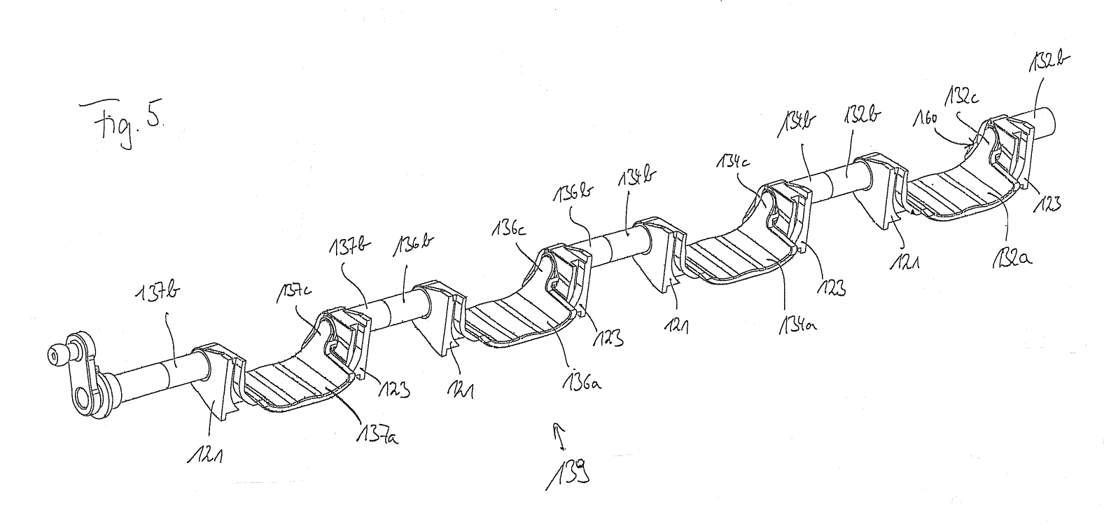

FIG. 5 is a perspective representation of the valves, bearing bushes and actuating element of the valve device of the second embodiment of FIG. 4, and

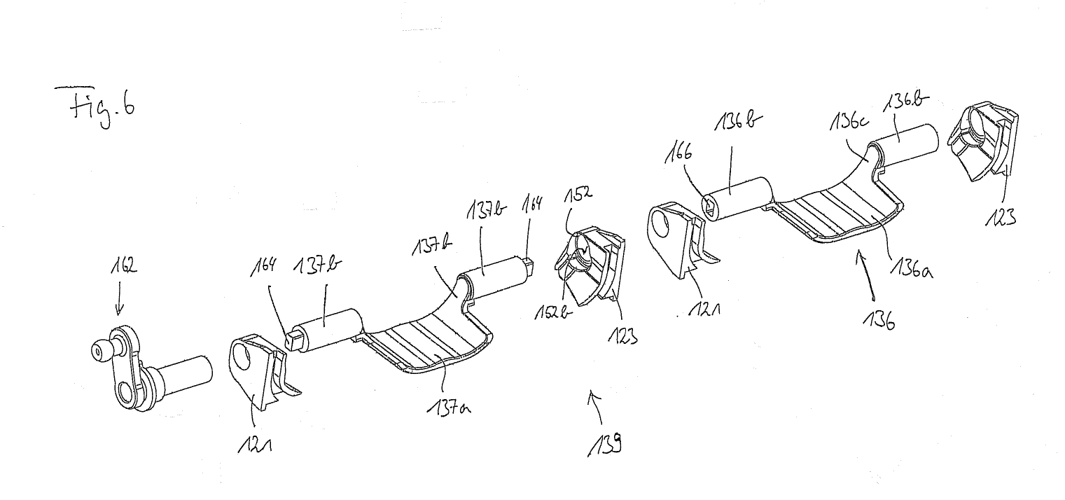

FIG. 6 is an exploded view of the two valves of the valve arrangement of FIG. 5 lying axially closest to the actuating element.

FIG. 1 shows a first embodiment of a valve device according to the invention, designated overall as 10.

The valve device 10 comprises three duct systems 12, 14 and 16, arranged next to each other.

To this end, the valve device 10 may comprise an outer housing 18, which is preferably formed as an integral component and in which further components of the valve device 10 may be accommodated.

Further, in the example illustrated the valve device 10 comprises a housing 20 associated with the duct system 12, a housing 22 associated with the duct system 14 and a housing 24 associated with the duct system 16.

In the example illustrated, in which the valve device 10 comprises three flow duct portions 26, 28 and 30, preferably one in each duct system, three housings 20, 22 and 24 may thus be provided, which may be formed separately from one another, as in the example shown in FIG. 1, or which may deviating thereof also be constructed integrally with one another, as is for example the outer housing 18 in the example illustrated.

Moreover, the valve device 10 may comprise a seal arrangement 31, in order to connect the valve arrangement 10 in the direction of the flow duct portions 26, 28 and 30 sealingly to a not shown connection piece. The seal arrangement 31 may furthermore serve to seal off a gap which may possibly exist between a housing 20, 22 or 24 and the outer housing 18.

It should be explicitly pointed out that, unlike in the representation of FIGS. 1 and 2, the valve device 10 may also comprise just one housing 20, two housings 20 and 22 or four or five or six or more housings with or indeed without appropriately formed outer housings or outer housing portions.

Since the housings 20, 22 and 24 in the example shown in FIG. 1 are preferably formed substantially identical in shape to simplify manufacture and assembly, only the housing 20, with the valve 32 accommodated therein, will be described below, with explicit reference being made to the fact that the valves 34 and 36 in the housings 22 or 24 may be identically formed, such that this description given of the housing 20 and its interior also applies to the housings 22 and 24.

The seal arrangement 31 mentioned above is preferably a one-piece seal element with housing seal portions 38, 40 and 42, which may be connected by webs 44 to form an integral component.

Furthermore, the seal arrangement 31 may comprise preferably integrally attached sealing loops 46 at its ends, which may serve to seal off terminal shaft stump recesses 48 on the outer housing 18, for accommodating terminal shaft stumps of the valves 32, 34 and 36, relative to a connection piece.

The seal arrangement 31 is preferably formed, for example by injection moulding, from a flexible and soft material particularly well suited to sealing, in any case from a more flexible and soft material than the outer housing 18, which should not exhibit any deformation or only the smallest possible deformation, in the case of intended loads being applied.

A material is “more flexible and soft” than a different further material in the sense of this application if two test specimen, which in an unloaded state have the same shape and the same dimensions, are exposed to the same load, and the text specimen made of that material deforms more strongly with respect to its original shape and dimensions that the specimen made of the different further material.

The housing 20 and the valve 32 provided therein for relative rotation relative to the housing 20 about a valve axis K were produced by moulding, preferably by injection moulding, in a common moulding tool in a common moulding step from an identical moulding material.

To this end, a valve shaft element 50, which is made from more wear-resistant material than the valve 32 and the housing 20, was threaded into bearing bushes 52 preferably prior to the moulding step and inserted together therewith into corresponding cavities and accommodations in the moulding tools.

This made it advantageously possible to encapsulate the valve shaft element 50 with moulding material to form the valve 32, in particular to encapsulate by injection moulding.

The valve 32, which preferably comprises a valve body 32a and valve shaft portions 32b, is preferably supported in the housing 20 with two bearing bushes 52 arranged spacedly in the axial direction relative to the valve axis K. The valve body 32a is preferably arranged axially between the bearing bushes 52, such that forces arising operationally, for instance through gas flow along the flow duct portion 26, do not entail the risk of significant sagging of the valve 32 in the region of the duct axis K, which significantly increases the operational reliability of the valve device 10.

In the example illustrated, the valve shaft portions 32b preferably formed integrally onto the valve body 32a fill a region located radially inside the bearing bush 52 and contact the bearing bush 52 at a radially inner surface, which is formed preferably cylindrical to assist in rotational supporting of the valve 32. The inner surface of the bearing bush 52 may additionally comprise undercut geometries, for instance projections surrounding the duct axis K and the like, to improve retention or grip of the bearing bush 52 on the valve shaft portion 32b.

On the other hand, the housing 20 is injection moulded radially externally around the bearing bushes 52 at the locations accommodating the bearing bushes 52, such that the housing 20 is materially separated from the valve 32, in particular from the valve shaft portions 32b by the bearing bushes 52, so as to allow relative mobility between valve 32 and housing 20 at the bearing location.

In FIG. 2 the bearing situation can be seen clearly in the partial section through the duct system 16.

It is particularly clearly visible herein that the housing 24, like the other housings 20 and/or 22 of the valve device 10, may comprise a bearing extension 24a, which may rest against a radially outer surface 52a of the bearing bush 52 after demoulding of the valve device 10. The radially outer surface 52a of the bearing bush 52 may also comprise an undercut geometry, for improving retention or grip of the bearing bush 52 on the housing.

By using the exact same moulding material to produce the housing on the one hand and the valves on the other hand, it is moreover possible to achieve substantially uniform, standardised bearing clearance in terms of the supporting for relative rotation of the valves on the housing.

As is additionally revealed by FIG. 2, the individual housings 20, 22 and 24 are inserted into spaces appropriately provided in the outer housing 18. The seal arrangement 31 seals off an annular gap between the housings 20, 22 and 24 and the outer housing 18.

At the end face opposite to the seal face 31a of the seal arrangement 31, an anchoring profile 31b may be formed on said seal arrangement 31, to ensure anchoring of the seal 31 on the housings 22, 22 or 24 and/or on the outer housing 18.

The coupling shaft element 50 is in the present case preferably formed as a prism, for example a cuboid, to simplify the introduction and/or transfer of a torque acting around the valve axis K. For example, the end regions 50a and 50b visible in FIG. 1 may serve as interlocking geometries for coupling of actuating elements for example, which are not shown in FIGS. 1 to 3c, with which an actuator actuating the valves 32, 34 and 36 may act on the valves 32, 34 and 36 to adjust them.

The cross-sectional representation of FIG. 3a substantially reveals that the valve 32, in particular the valve body 32a of the valve device 10 in the example currently under discussion, may be mirror-symmetrical to a plane of symmetry containing the valve axis K and extend in particular along a plane.

In addition, FIG. 3a shows an annular gap 54 between the valve body 32a and the associated housing 20, which remains even when the valve 32 is in its shut-off position shown in FIG. 3a. The annular gap 54 extends more precisely along the circumference of the valve body 32a in each case between the valve shaft portions 32b.

The region designated 111b in FIG. 3a is shown in enlarged cross section in FIG. 3b.

It is clear therefrom how, between an outer edge 56 of the valve body 32a and an inner wall 58 of the housing 20 facing the outer edge 56, a moulding material membrane 60 is connected both with the valve body 32a and with the housing 20, bridging the annular gap 54.

The moulding material membrane 60 is produced in the common moulding step in which both the valve 32 and the housing 20 are formed.

FIG. 3b thus shows the valve device 10 in a semifinished product state.

The portion designated 111c in FIG. 3b, which contains the annular gap 54, is shown on an enlarged scale in FIG. 3c.

It is shown therein that the moulding material membrane 60 has a significantly lower material thickness compared with the material thickness of the valve body 32a, in particular in the outer peripheral area 56 thereof, for instance exhibits a material thickness of 1 to 20% of the material thickness or average material thickness of the valve body 32a.

Before the valve device 10 is brought into service, the moulding material membrane 60 is severed using a suitable tool, for instance a blade. This may take place at the valve body 32a, in which case the moulding material membrane 60 remains on the housing 20 as a burr, or it may take place at the housing 20, in which case the moulding material membrane 60 remains on the valve body 32a as a burr. The latter is preferred due to the associated flow conditions in the associated flow duct portion.

In principle, however, the possibility should also not be ruled out of severing the moulding material membrane 60 in a region between the two components: valve body 32a and housing 20, such that the moulding material membrane 60 remains as a partial burr in one part on the valve body 32a and in the other part on the housing 20.

After severing, the moulding material membrane 60 forms as a burr or partial burr a precisely fitting seal for the annular gap 54, such that leakage flow through the annular gap 54 may be prevented or at least greatly reduced when the valve 32 is in the shut-off position.

In the case of joint moulding, in particular injection moulding, of valve 32 and housing 20, the moulding material membrane 60 is produced without appreciable costs resulting from manufacturing effort and assembly effort and subsequently provides a very effective annular gap seal.

FIGS. 4 and 6 show a second embodiment of the present invention. In this second embodiment, elements and element portions which are the same as in the first embodiment in FIGS. 1 to 3c are provided with the same reference numerals increased by the number 100.

The valve device 110 shown here comprises four substantially parallel flow duct portions 126, 128, 130 and 133, which are formed in a common housing 120.

Alternatively, the housing 120 may be subdivided in such a manner that one or more subgroups of flow duct portions are formed in one housing part. It may likewise be conceivable to construct a separate housing for each flow duct portion.

As will be explained in greater detail further below, the housing 120 may be of multipart construction to simplify assembly of the embodiment of a valve device 110 shown herein.

The valves 132, 134, 136 and 137 may be constructed with curved valve bodies 132a, 134a, 136a and 137a corresponding to the shape of the associated flow duct portion, which are then preferably arranged at a distance from the valve axis K, around which the entire valve arrangement 139 may be rotated relative to the housing 120. In the passage position shown in FIG. 4, the valve bodies 132a, 134a, 136a and 137a then preferably lie close against the housing 120, forming a narrow gap 141.

In the passage position shown in FIG. 4, in which the respective flow duct portions in the housing 120 have a substantially maximum flow area, the valve bodies may then fit snugly against the respective inner wall portions of the housing 120. Thus, in the passage position of the valve arrangement 139 there is preferably no valve component projecting into the flow duct portion associated therewith.

The second embodiment discussed here of a valve device 110 according to the invention will be described below with reference to the valve 137 on the far left in FIG. 4. Where other valves than the described valve 137 differ therefrom, in the context of this description reference may be made specifically to the differences.

The valve 137 comprises the already stated valve body 137a, from which valve shaft portions 137b project on both axial sides relative with respect to the valve axis K.

The valve shaft portions 137b are preferably formed integrally with the valve body 137a by way of web portions 137c.

Both longitudinal ends of the valve shaft portions 137b remote from the valve body 137a may comprise interlocking geometries which may serve as torque-transmitting connection with the respective adjacent valve, here for example valve 136, and/or with an actuating element 162.

In the example shown in FIG. 4 both interlocking geometries may be formed as projections 164.

Valves 137 and 134 may then be formed substantially identical, and valves 136 and 132 may be formed substantially identical, the difference between adjacent valves 137 and 136 (see FIG. 6) possibly being that the valve 136 comprises coupling recesses 166 instead of projections 164.

In the example illustrated, at both longitudinal ends of the valve shaft portions 136b remote from the valve body 136a the valve 136 has recesses 166 into which the projections 164 of adjacent valves may be introduced, in order to connect the valves together in a torque-transmitting manner.

The situation illustrated in FIGS. 4 to 6 may additionally be modified with regard to required assembly in that each valve has a projection 164 at one longitudinal end of a valve shaft portion and a corresponding recess 166 at the respective other longitudinal end. If, in terms of the position relative to the valve body, the same valve shaft portions then always comprise a projection and the respective other ones comprise a recess, it is sufficient to manufacture one kind of valve. Substantially identical valves may thus be plugged together to form a valve arrangement 139.

Once adjacent valves and/or an actuating element 162 have been plugged together, the components plugged for torque transmission may be additionally joined together by adhesion, welding or any other desired suitable method so as to be non-detachable when used as intended.

A laser welding method is here preferably recommended, which minimises the arising thermal warping which may arise and thus ensures the greatest possible dimensional stability, in conjunction with smooth relative rotatability of the valve arrangement 139 relative to the housing 120.

It is likewise conceivable, although not preferred due to the greater assembly effort, to construct all the valves with coupling recesses 166 and to introduce separately constructed connecting blocks in the form of the coupling projections 164 into the coupling recesses 166 of adjacent valves. Although in this solution too all the valves are then substantially geometrically identical, the assembly effort resulting from introduction of the coupling blocks is undesirably high.

The coupling projections 164 are preferably of prismatic structure, such that, when combined with the corresponding coupling recesses 166, they can transmit torque at the sides of their circumferential surfaces. In the example illustrated, the coupling projections 164 are designed as cuboids. However, it is likewise conceivable to design the coupling projections 164 as a triangular prism, a pentagonal prism or an irregular prism.

It is likewise sufficient to form the recesses 166 in such a way that portions of the inner circumferential surface of a recess 166 come to bear against portions of the circumferential surface of the coupling projections 164 and at this bearing location a torque about the valve axis K is transmittable between two valves coupled in this way.

However, to achieve an as exact as possible geometry of the assembled valve arrangement 139, it is preferable for valve projections 164 and valve recesses 166 substantially to complete one another when assembled, i.e. to be of mutually complementary construction, wherein this is not intended to mean that the coupling recess 166 is completely filled by the coupling projection 164 when being in a state combined with a coupling projection 164. Conventionally, already for manufacturing reasons, the coupling recess 166 is formed axially longer than the coupling projection 164. However, it is advantageous for coupling projection 164 and coupling recess 166 to have at least one axial portion in which virtually the entire circumference of a coupling projection 164 rests against the circumference of the coupling recess 166.

In this way, the valves may be manufactured individually and assembled with little effort into a valve arrangement 139 of any desired length.

The valve arrangement 139, which in FIGS. 4 and 5 comprises four valves and one actuating element 162, may in alternative embodiments comprise just one valve 137 and one actuating element 162 or may, as shown in FIG. 6, comprise just two valves 137 and 136 and one actuating element 162 or may comprise just three, five, six or more valves, in each case with or without an actuating element 162.

As is likewise shown in the Figures, the actuating element also has a corresponding interlocking geometry, in this case a coupling recess 166.

As shown in FIGS. 5 and 6, each valve shaft portion is surrounded by an supplementary housing element 121 or 123.

The supplementary housing elements 121 or 123 may be substantially identical and differ merely in terms of their direction of curvature. For example, the supplementary housing elements 121 and 123 may be mirror-symmetrical relative to a mirror plane of symmetry orthogonal to the duct axis K.

When each valve has its associated supplementary elements 121 and 123, the valves needed to form a valve arrangement 139 may be combined together in torque-transmitting manner by way of the above-described interlocking geometries and preferably fixed together non-detachably. The same applies to an actuating element 162, which may be connectable to the end of the valve arrangement 139 in torque-transmitting manner. Then the valve arrangement 139 formed in this way may be inserted into the basic housing element 125, which is shown in FIG. 4, wherein the respective supplementary housing elements 121 and 123 then complete the basic housing element 125 to form a housing with complete flow duct portions.

A bearing bush 152 may in turn be provided between the supplementary housing elements 121 or 123 and the valve shaft portions 137b, 136b, 134b, 132b passing through them.

In the present case the valves, for example the valve 137, may be moulded, for example by injection moulding, in a common moulding tool in a common moulding step with the supplementary housing elements 121 and 123. To this end, a set of bearing bushes 152, which after demoulding separate the supplementary housing elements 121 and 123 geometrically from the valve shaft portions 137b etc., was preferably inserted into the moulding tool at corresponding locations in the moulding tool prior to the moulding step and encapsulated with moulding material, in particular encapsulated by injection moulding.

The supplementary elements thus abut against an outer surface 152a of the bearing bush 152, while the valve shaft portions 137b abut against an inner surface 152b (see FIG. 6) of the bearing bushes 152.

A valve with the associated housing bearing arrangement may therefore be produced highly accurately in a single moulding step with a small, substantially uniform bearing clearance and without major effort.

Since in FIGS. 4 to 6 the valve arrangement 139 is illustrated with the associated valves in the passage position, the moulding material membrane 160 moulded on during the moulding process between the supplementary housing elements 121 and 123 and the associated valve body remains connected only to the respective valve body.

1. A method of producing by moulding, in particular injection moulding, a valve device, in particular a throttle device, preferably for use in motor vehicles, the valve device comprising a housing, which surrounds a flow duct portion, and additionally comprising a valve accommodated on the housing and movable relative thereto such that, by relative adjustment of the valve relative to the housing, the effective flow area of the flow duct portion is modifiable,
characterised in that the housing and the valve already accommodated thereon are formed shapingly in a moulding tool in a common moulding step from a flowable moulding compound, with one-piece formation of a moulding material membrane, which is thin compared with the wall thicknesses of the housing and of the valve, together with the valve and the housing, the moulding material membrane being provided between an outer valve portion, preferably more precisely between an outer valve edge, and a housing portion surrounding the valve portion, preferably the valve edge, in a shut-off position of the valve relative to the housing, in which shut-off position the flow area of the flow duct portion is as a rule minimal.

2. A method according to claim 1,
characterised in that that it comprises the step of severing the moulding material membrane.

3. The method according to claim 1,
characterised in that the valve in the finished valve device is provided on the housing so as to be rotatable relative thereto about a valve axis (K), the method comprising the following method steps:
inserting a valve shaft element into the mould, and
moulding, in particular injection moulding, the valve onto the valve shaft element or
encapsulating by (over)moulding, in particular encapsulating by injection moulding, the valve shaft element with the valve.

4. A method according to claim 1,
characterised in that the valve in the finished valve device is provided on the housing so as to be rotatable relative thereto about a valve axis (K), the method comprising the following method steps:
inserting at least one bearing bush into the moulding tool, preferably two bearing bushes, particularly preferably such that a portion of a valve cavity of the moulding tool is positioned between two bearing bushes associated with the same valve, and
moulding, in particular injection moulding, moulding material contributing to formation of the valve onto a first valve bearing face, associated with the valve, of the bearing bush, and
moulding, in particular injection moulding, moulding material contributing to formation of the housing onto a second housing bearing face of the bearing bush, which second housing bearing face is different from the first valve bearing face and associated with the housing.

5. A method according to claim 3,
characterised in that it comprises the step of threading the valve shaft element into a bearing bush.

6. A semi-finished product for a valve device, in particular a throttle device, preferably for use in motor vehicles, the finished valve device comprising a housing which surrounds a flow duct portion, and additionally comprising a valve accommodated on the housing so as to be movable relative thereto such that, by relative adjustment of the valve relative to the housing, the effective flow area of the flow duct portion is modifiable, in particular produced according to a method according to claim 1, characterised in that the valve, in particular at least an outer valve edge, and a housing portion surrounding the valve when the valve device is in the operational state are connected by means of a moulding material membrane which is thin compared with the wall thickness of the housing and the valve and are thus formed in one piece.

7. A semi-finished product according to claim 6,
characterised in that the valve comprises at least one valve shaft portion, with which the valve is supported rotatably on the housing, and comprises a valve body, which is accommodated in the flow duct portion to modify the flow area, the at least one valve shaft portion being formed in one piece with the valve body.

8. A semi-finished product according to claim 6, characterised in that the valve comprises two valve shaft portions which are substantially coaxial relative to the valve axis (K), the valve body being provided axially between the valve shaft portions (32b, 34b, 36b; 132b, 134b, 136b, 137b).

9. A semi-finished product according to claim 1, characterised in that it comprises a plurality of valves, adjacent valves being couplable or coupled together for joint movement by interlocking geometries.

10. A semi-finished product according to claim 9, characterised in that the one of two valve shaft portions connected to a valve body comprises a coupling geometry, preferably at a free axial end thereof, and the respective other valve shaft portion comprises a counter coupling geometry, wherein the coupling geometry and the counter coupling geometry being couplable in interlocking manner for joint rotational movement about the valve axis (K).

11. A semi-finished product according to claim 10, characterised in that one geometry (166) of coupling geometry and counter coupling geometry comprises a recess and the respective other geometry comprises a torque-transmitting projection introducible into the recess, preferably a projection complementary to at least one portion of the recess circumference.

12. A valve device, in particular a throttle device, preferably for use in motor vehicles, the valve device comprising a housing, which surrounds a flow duct portion, and additionally comprising a valve accommodated on the housing and movable relative thereto such that, by relative adjustment of the valve relative to the housing, the effective flow area of the flow duct portion is modifiable, preferably produced using a method according to of claim 1,
characterised in that the valve, in particular an outer valve edge of the at least one valve and/or a portion, surrounding the valve, of the housing comprises, as gap seal for the gap remaining between the valve and the housing when the flow area is maximally reduced by the valve, preferably completely circumferential burr of the same moulding material from which the valve portion, in particular the valve edge of the valve, preferably the entire valve, and the housing portion are produced.

13. A valve device according to claim 12, wherein the valve, in particular at least an outer valve edge, and a housing portion surrounding the valve when the valve device is in the operational state are connected by means of a moulding material membrane which is thin compared with the wall thickness of the housing and the valve and are thus formed in one piece.

14. A valve device according to claim 13, wherein the one of two valve shaft portions connected to a valve body comprises a coupling geometry, preferably at a free axial end thereof, and the respective other valve shaft portion comprises a counter coupling geometry, wherein the coupling geometry and the counter coupling geometry being couplable in interlocking manner for joint rotational movement about the valve axis (K) and wherein the valve comprises two valve shaft portions which are substantially coaxial relative to the valve axis (K), the valve body being provided axially between the valve shaft portions, characterised in that the valve device comprises an actuating element, which may be or is connected to at least one valve to introduce an actuating moment for relative rotation of valve and housing, the actuating element also comprising one geometry out of coupling geometry and counter coupling geometry.

15. A valve device according to claim 13, wherein the valve comprises two valve shaft portions which are substantially coaxial relative to the valve axis (K), the valve body being provided axially between the valve shaft portions, characterised in that, in addition to the provided interlocking geometries, a plurality of individually produced valves are connected together operationally non-detachably, by bonding, for instance by laser welding, or by adhesion or otherwise.

16. A valve device, in particular a throttle device, preferably for use in motor vehicles, the valve device comprises a housing, which surrounds a flow duct portion, and additionally comprises a valve accommodated on the housing and movable relative thereto such that, by relative adjustment of the valve relative to the housing, the effective flow area of the flow duct portion is modifiable, characterised in that the valve, in particular an outer valve edge of the at least one valve and/or a portion, surrounding the valve, of the housing comprises, as gap seal for the gap remaining between the valve and the housing when the flow area is maximally reduced by the valve, a preferably completely circumferential burr of the same moulding material from which the valve portion, in particular the valve edge of the valve, preferably the entire valve, and the housing portion are produced.
